(19) United States
(12) Patent Application Publication
(10) Pub. No.: US 2012/0215965 A1
(43) Pub. Date: Aug. 23, 2012

(54) Storage Device and Computer Using the Same

(75) Inventors: Ryoichi Inada, Hitachi (JP); Ryo Fujita, Hitachi (JP); Takuma Nishimura, Hitachi (JP); Koji Matsuda, Hitachiota (JP)

(73) Assignee: Hitachi, Ltd., Tokyo (JP)

(21) Appl. No.: 13/372,800

(22) Filed: Feb. 14, 2012

(30) Foreign Application Priority Data
Feb. 23, 2011 (JP) 2011-036717

(51) Int. Cl. G06F 12/10; G06F 12/08

(52) U.S. Cl. 711/103; 711/E12.058; 711/E12.017

(57) ABSTRACT

A nonvolatile memory stores therein a plurality of partitioned translation tables which are created by partitioning a logical-to-physical address translation table in a page unit. A RAM stores therein a logical-to-physical address translation table cache for storing at least the one or more partitioned translation tables, a translation-table management table for managing the partitioned translation tables, and a cache management table for managing the logical-to-physical address translation table cache. The translation-table management table includes a cache presence-or-absence flag and a cache entry number, the cache presence-or-absence flag being used for indicating that the partitioned translation tables are stored into the logical-to-physical address translation table cache, the cache entry number being used for indicating storage destinations of the partitioned translation tables in the logical-to-physical address translation table cache. Reading/writing processings of information in the logical-to-physical address translation table between the nonvolatile memory and the RAM are performed in the page unit.

### BACKGROUND OF THE INVENTION

The present invention relates to a storage device and a computer using the same.

A magnetic-disc storage device is commonly used as the auxiliary storage device for information appliances. In this magnetic-disc storage device, data reading/writing operations are performed for each of storage units which are referred to as “sectors”.

In recent years, in substitution for the magnetic-disc storage device as described above, there has been a considerable increase in the alternative employment of storage devices which use semiconductor memories as their storage media. Of these storage devices, a storage device which uses a flash memory as its storage medium is gradually becoming the mainstream at present. Here, the flash memory is a kind of the EEPROM (:Electrically Erasable Programmable Read-Only Memory), i.e., the electrically-erasable and rewritable nonvolatile semiconductor memory.

This flash memory is superior to the magnetic-disc storage device in its data reading/writing speeds. In association with the use of this flash memory, however, there exist the following four limitations: The first limitation is as follows: The unit of reading/writing data (which, generally, is referred to as “a page”) and the unit of erasing data (which, generally, is referred to as “a block”, and which is constituted from a plurality of pages) are determined and fixed. Accordingly, the block is larger than the page in size. The second limitation is as follows: When overwriting data, the data needs to be rewritten again after erasing the data once temporarily. The third limitation is as follows: When writing data into a certain page within a block, the data needs to be written in accordance with the sequence of continuous page numbers. The fourth limitation is as follows: The upper-limit of the erasing number-of-times is determined and fixed on each block basis.

In JP-A-2009-275048, the above-described flash-memory characteristics are taken into consideration. Then, based thereon, the proposal has been made concerning a memory-controlling method for executing the high-performance implementation and long-life implementation of the flash-memory-used storage device. Here, the disclosure is given as follows: “In the case of managing the nonvolatile semiconductor memory, physical blocks are classified into three types, i.e., scratch blocks, data blocks, and erased blocks. A data writing processing from a host device is performed into a scratch block. Then, if empty pages within the scratch block are occupied and lost, this scratch block is addressed as a data block thereinafter. Moreover, as a new scratch block, a single erased block is newly allocated from among the erased blocks. Also, if there occurs a shortage of the erased blocks, a data block containing a small amount of effective data is selected from among the data blocks. Furthermore, all of the effective data contained in this data block are copied into the scratch block. After that, the block erasing is performed, thereby acquiring an erased block.”

Also, in JP-A-11-203191, the proposal has been made regarding a method for suppressing the capacity of a RAM installed into the flash-memory-used storage device. Here, the disclosure is given as follows: “There are provided a first address translation table stored into a volatile storage member, and a second address translation table stored into a nonvolatile storage member. The physical location of the second address translation table stored into the nonvolatile storage member is acquired from a logical sector address associated with a request received by a reception member, and the first address translation table stored into the volatile storage member. Moreover, the second address translation table stored into the nonvolatile storage member is acquired based on the physical location acquired by a first address acquisition member. Furthermore, data is written into the nonvolatile storage member from the logical sector address associated with the request received by the reception member, and the second address translation table.”

Also, in JP-A-2010-157142, the proposal has been made concerning a method for speeding up the response speed to a data writing request from a host computer. Here, the disclosure is given as follows: “A WC (: Write Cache)-expelling control unit compares a WC-resource usage amount with an AF (:Auto Flush) threshold value Caf whose value is smaller than the upper-limit value C1mt. Then, if the WC-resource usage amount has exceeded the AF threshold value Caf, the WC-expelling control unit confirms a state of the organized arrangement in a NAND-type flash memory. Then, if the organized arrangement in the NAND-type flash memory has progressed sufficiently, the control unit expels the data out of the WC into the NAND-type flash memory earlier than usual.”

### SUMMARY OF THE INVENTION

In JP-A-2009-275048, the description has been given concerning the memory-controlling method for managing a data structure in the page unit. Since this memory-controlling method manages the data in the page unit, this method allows implementation of the high-speed processing. In this memory-controlling method, however, the capacity of a logical-to-physical address translation table becomes larger as compared with the one in a memory-controlling method for managing data in the block unit. What is more, the capacity of this logical-to-physical address translation table increases in proportion to the storage capacity of the storage device. On account of these situations, executing the large-capacity implementation of the storage device requires the set-up of a large-capacity memory for storing the logical-to-physical address translation table. As a result, there exists a problem of bringing about a large-sized implementation of the storage device and an increase in its cost.

In JP-A-11-203191, the description has been given regarding the method for reducing the RAM capacity by storing the logical-to-physical address translation table in such a manner as to be partitioned into the RAM and the flash memory. According to this method, it becomes possible to accomplish the tremendous reduction in the RAM capacity, which has been set as the problem in JP-A-2009-275048. In this method, however, the writing by the mount of two pages, i.e., the address-translation-table information and the data, turns out to occur in response to a writing processing from the host computer. On account of this situation, the processing speed becomes lowered as compared with the one implemented in a case of not writing the address-translation-table information. As a result, there exists a problem of bringing about a wasted expenditure of the rewriting number-of-times of the flash memory.

In order to solve the above-described problem, a method for suppressing the lowering in the processing speed while reducing the RAM capacity simultaneously is made conceivable by employing the following scheme: Namely, the logical-to-physical address translation table is stored into the nonvolatile memory. Simultaneously, a partial content of the logical-to-physical address translation table is held into the RAM as a cache.

An example of the cache-used data-managing method like this has been disclosed in JP-A-2010-157142, i.e., the data-controlling method between the WC (:Write Cache) and the NAND-type flash memory.

In this data-controlling method, WC track information is used as the data-controlling information inside the WC. The WC track information includes information which is held in the cache, such as track addresses and in-track effective sector number. The WC track information, however, holds only the information by the amount of the cache's entry. As a result, even if basically the same cache management information is applied to the cache management of the logical-to-physical address-translation-table information, there still exists the following problem: Namely, it is impossible to grasp at which physical address within the nonvolatile memory the address-translation-table information is stored which is not held in the cache.

Accordingly, in the present invention, an object is to provide a storage device and a computer installing this storage device therein. Here, the storage device and the computer allow prevention of the lowering in the processing speed, and allow the physical-address management within the nonvolatile memory, while simultaneously allowing prevention of a large-sized implementation of the storage device and an increase in its cost.

In order to solve the above-described problems, in the present invention, the logical-to-physical address translation table is stored into the nonvolatile memory. Simultaneously, a partial content of the logical-to-physical address translation table is held into the RAM as a cache. This scheme makes it possible to suppress the lowering in the processing speed while reducing the RAM capacity simultaneously. Also, the management is performed as to at which location (i.e., at which physical address) within the nonvolatile memory the address-translation-table information is stored which is not held in the cache. Simultaneously, there is provided information for identifying whether or not the address-translation-table information is held in the cache. This scheme makes it possible to implement the cache management of the logical-to-physical address translation table.

The present application includes a plurality of configuration units for solving the above-described problems. Its one example is as follows: A storage device 2, including a nonvolatile memory 22 which includes pages 2220 and blocks 222, each of the pages 2220 being a certain predetermined unit of writing data, each of the blocks 222 being a unit of erasing data which is larger than the unit of writing data in size, a RAM 23 which is capable of performing data read/writing processings therefrom/therein, and a memory controller 21 for performing the data reading/writing processings from/into the nonvolatile memory 22 and the RAM 23, wherein the nonvolatile memory 22 stores data 221 and a plurality of partitioned translation tables 240, the writing processing of the data 221 being performed into the nonvolatile memory 22 by an instruction processing device 4, the plurality of partitioned translation tables 240 being created by partitioning, in the page (2220) unit, a logical-to-physical address translation table 220 for managing storage locations of the data 221, the RAM 23 storing a logical-to-physical address translation table cache 230 for storing at least the one or more partitioned translation tables 240, a translation-table management table 235 for managing the partitioned translation tables 240, and a cache management table 236 for managing the logical-to-physical address translation table cache 230, the translation-table management table 235 storing a cache presence-or-absence flag 2352 and a cache entry number 2355, the cache presence-or-absence flag 2352 being used for indicating that the partitioned translation tables 240 are stored into the logical-to-physical address translation table cache 230, the cache entry number 2355 being used for indicating storage destinations of the partitioned translation tables 240 in the logical-to-physical address translation table cache 230, reading/writing processings for the information in the logical-to-physical address translation table 220 between the nonvolatile memory 22 and the RAM 23 being performed in the page (2220) unit.

According to the present invention, the logical-to-physical address translation table is stored into the nonvolatile memory. Simultaneously, only a necessary partial content of the logical-to-physical address translation table is held into the RAM. This scheme makes it possible to reduce the RAM capacity. Also, the partial content of the logical-to-physical address translation table held into the RAM is used as a cache. This scheme allows implementation of a reduction in the writing number-of-times of the logical-to-physical address-translation-table information into the nonvolatile memory, thereby making it possible to suppress the lowering in the processing speed.

Objects, configurations, and effects other than the above-described ones will become apparent from explanations of the following embodiments.

### BRIEF DESCRIPTION OF THE DRAWINGS

FIG. 1 is a diagram for illustrating a hardware configuration example for explaining an embodiment of the present invention;

FIG. 2 is a diagram for illustrating the internal configuration of a nonvolatile memory;

FIG. 3 is a diagram for indicating the utilization state of the nonvolatile memory in the present embodiment;

FIG. 4 is a diagram for summarizing the relationship between blocks and pages;

FIG. 5a is a diagram for illustrating a data configuration example of a block header page 2221;

FIG. 5b is a diagram for illustrating a data configuration example of a data page 2222;

FIG. 5c is a diagram for illustrating a data configuration example of a table page 2223;

FIG. 6 is a diagram for indicating the configuration of a logical-to-physical address translation table;

FIG. 7 is a diagram for indicating the configuration of a scratch-block management table;

FIG. 8 is a diagram for indicating the configuration of a data-block management table;

FIG. 9 is a diagram for indicating the configuration of an erased-block management table;

FIG. 10 is a diagram for indicating the configuration of a physical-block management table;

FIG. 11 is a diagram for indicating the configuration of a translation-table management table;

FIG. 12 is a diagram for indicating the configuration of a cache management table;

FIG. 13 is a processing flowchart in a case where a data reading processing is received from an instruction processing device;

FIG. 14 is a processing flowchart for a reading processing from a partitioned translation table;

FIG. 15 is a processing flowchart for a writing processing into a partitioned translation table;

FIG. 16 is a processing flowchart for an identifying processing of identifying a writable page;

FIG. 17 is a processing flowchart for an update processing of updating each type of management table;

FIG. 18 is a processing flowchart in a case where a data writing processing is received from the instruction processing device;

FIG. 19 is a processing flowchart for the update processing of updating each type of management table; and

FIG. 20 is a processing flowchart at the time of a block erasing processing.

### DESCRIPTION OF THE INVENTION

Hereinafter, referring to the drawings, the explanation will be given below concerning embodiments of the present invention.

### Embodiments

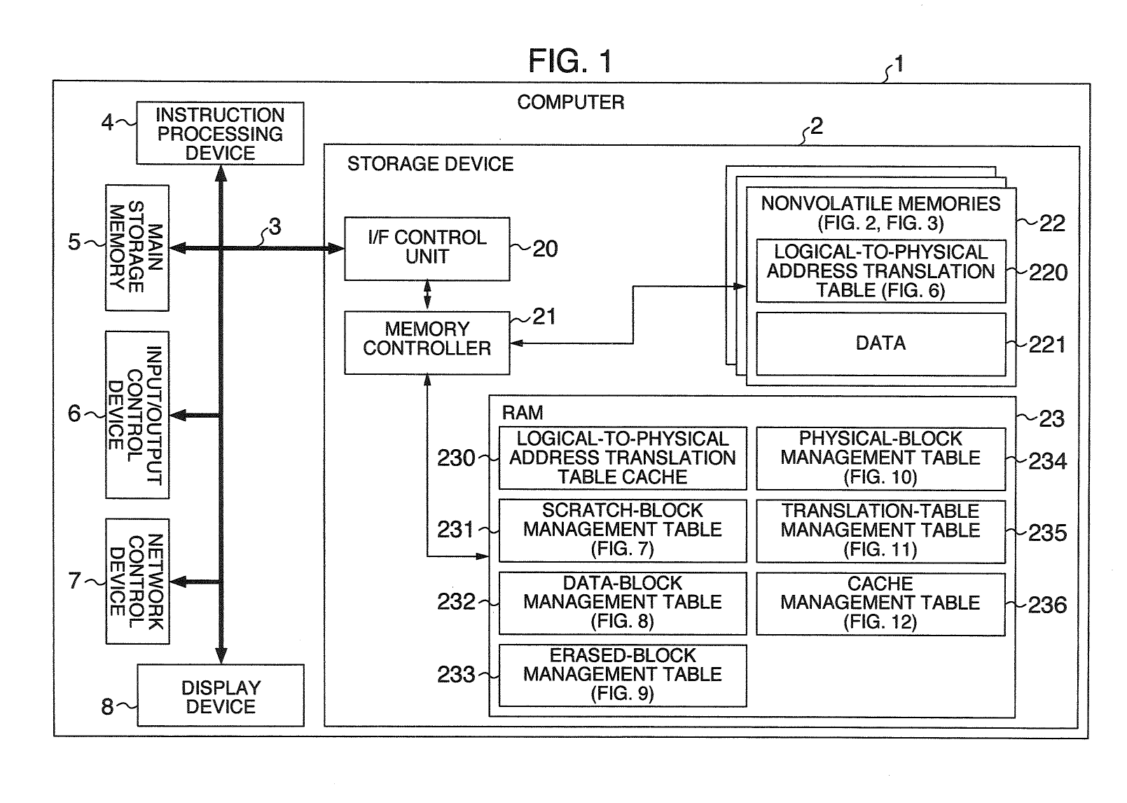

FIG. 1 is an example of the hardware configuration in the present embodiment. A computer 1 illustrated in FIG. 1 includes a storage device 2, an instruction processing device 4, a main storage memory 5, an input/output control device 6, a network control device 7, and a display device 8. These respective devices are connected to each other by a data bus 3.

Of these devices, the storage device 2 performs data reading/writing operations in accordance with processings from the instruction processing device 4.

The instruction processing device 4 processes instructions stored in the storage device 2 or the main storage memory 5, thereby performing the data reading/writing operations from/into the storage device 2 and the main storage memory 5, and performing processings for the input/output control device 6, the network control device 7, and the display device 8.

The main storage memory 5 performs the data reading/writing operations in accordance with the processings from the instruction processing device 4.

The input/output control device 6 is a device for controlling the input/output of data between (not-illustrated) external devices and the data bus 3. Mentionable examples of these external devices are a keyboard, a mouse, and the externally-installable storage device 2.

The network control device 7 is a device for controlling the input/output of data between (not-illustrated) networks and the data bus 3.

The display device 8 is a device for performing operations such as the display of data in accordance with the processings from the instruction processing device 4.

The storage device 2 includes an I/F (:interface) control unit 20, a memory controller 21, one or more nonvolatile memories 22, and a RAM 23.

The I/F control unit 20 performs the control over data between the instruction processing device 4 and the memory controller 21. The memory controller 21 performs data reading/writing operations within the nonvolatile memories 22 in accordance with the instructions from the instruction processing device 4. In accompaniment with the data reading/writing operations, the memory controller 21 performs a data updating operation within the RAM 23.

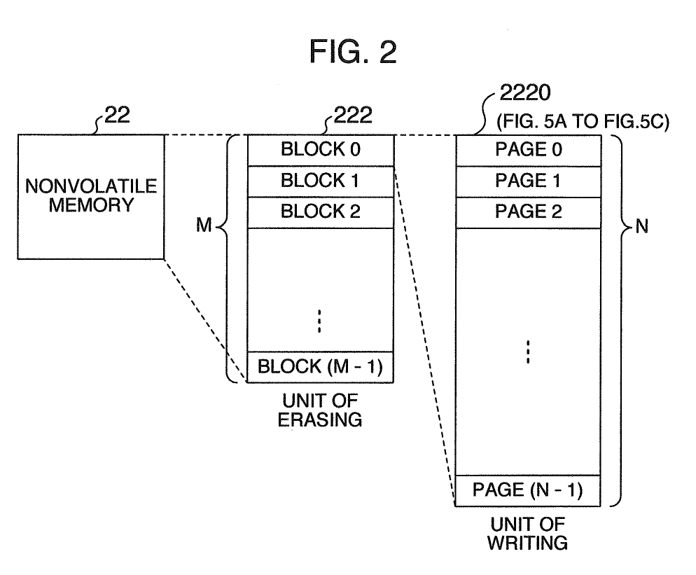

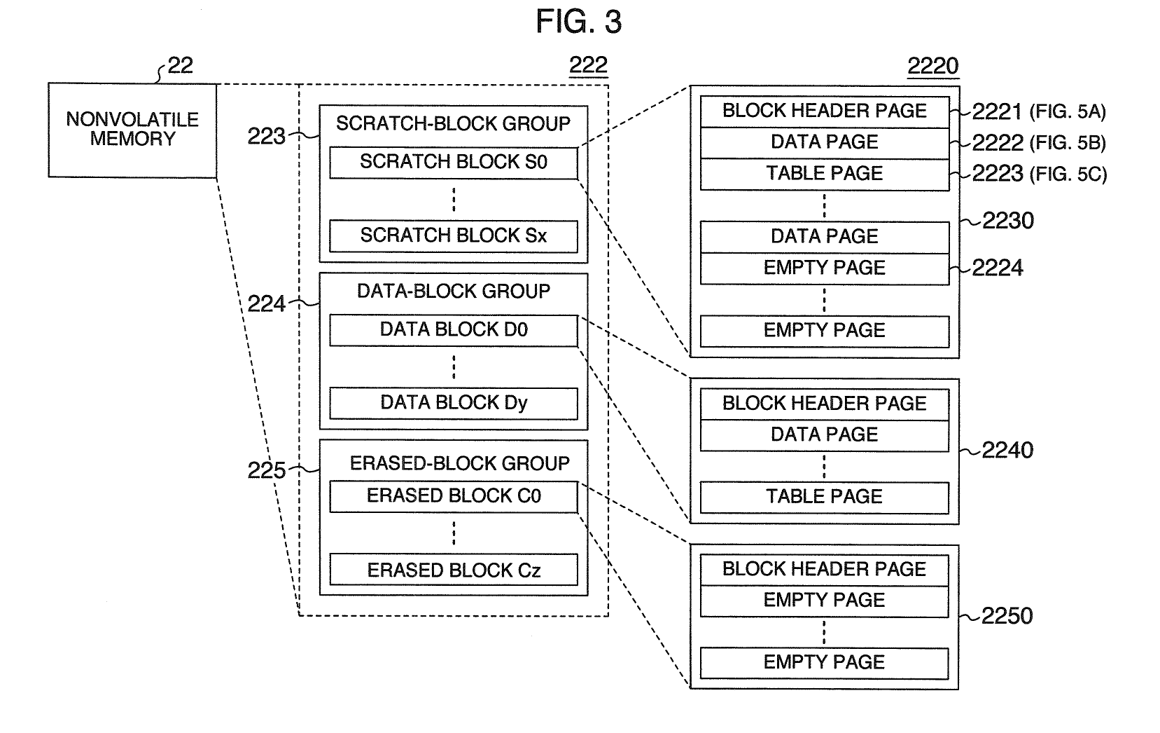

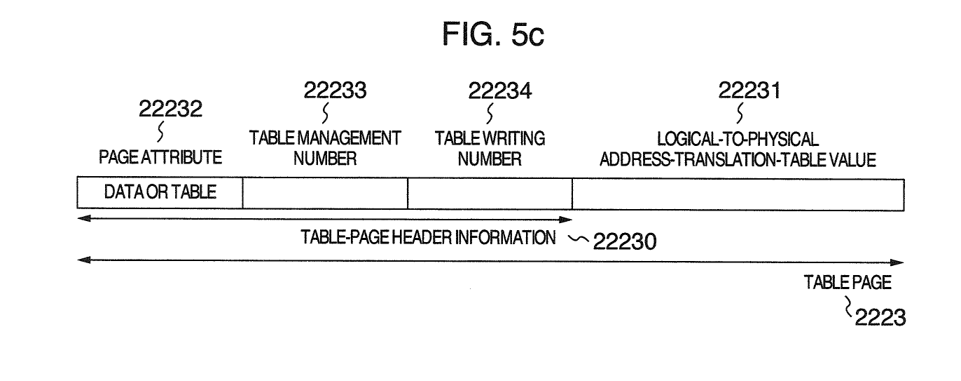

The nonvolatile memories 22 store therein a logical-to-physical address translation table 220, and data 221. Bach of the nonvolatile memories 22 described in the present embodiment refers to the following nonvolatile memory: Namely, this nonvolatile memory has a predetermined unit of writing data (i.e., a page), and a unit of erasing data (i.e., a block) which is larger than the unit of writing data in size. Also, when rewriting data, this nonvolatile memory necessitates the execution of this data erasing operation before rewriting this data. Incidentally, the contents of each nonvolatile memory 22 will be described later in detail, using FIG. 2 and FIG. 3. Also, an example of the logical-to-physical address translation table 220 is illustrated in FIG. 6.

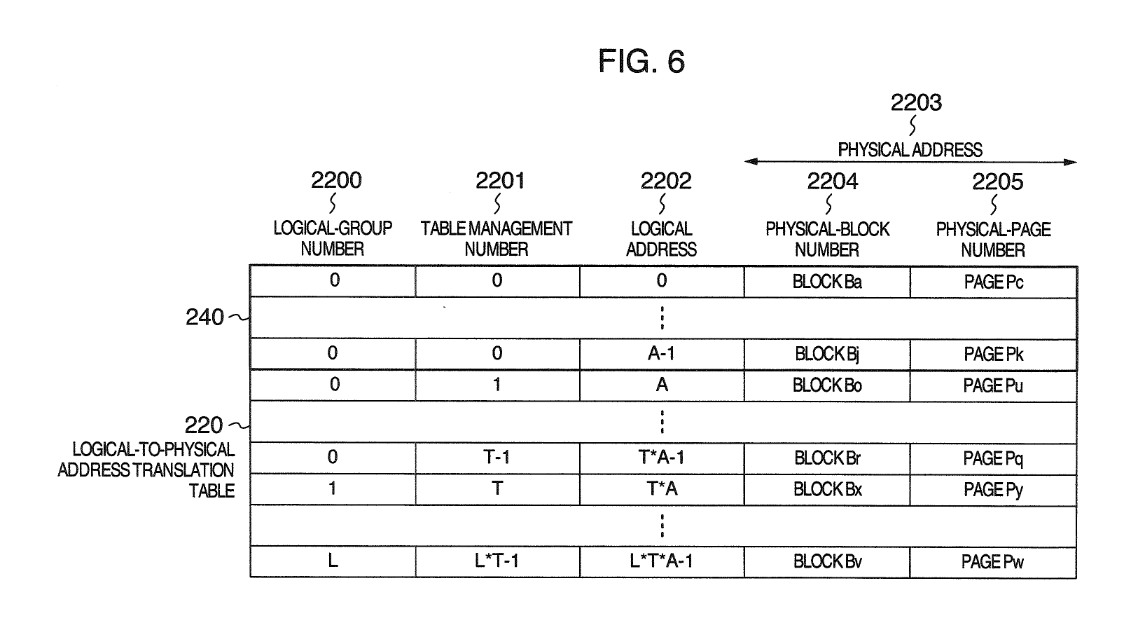

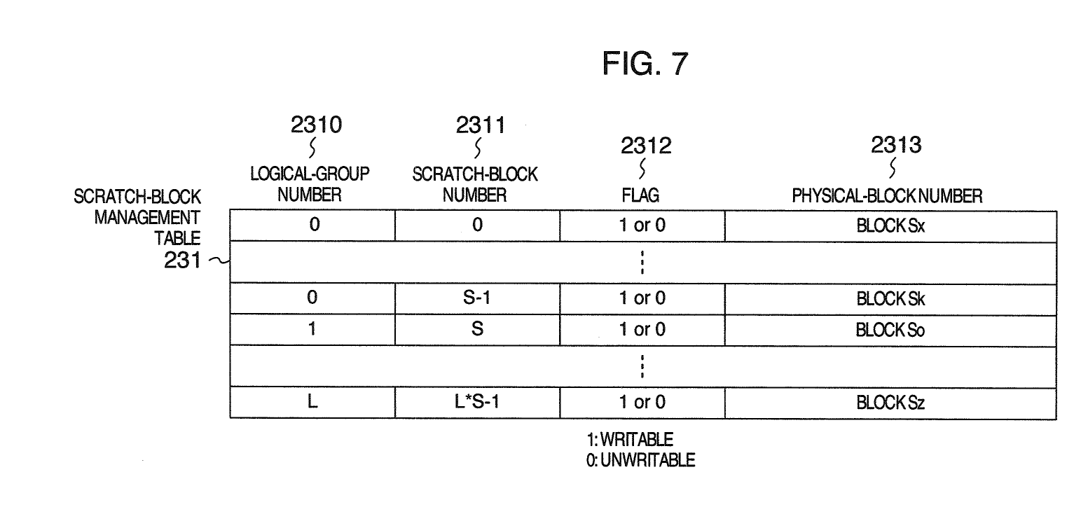

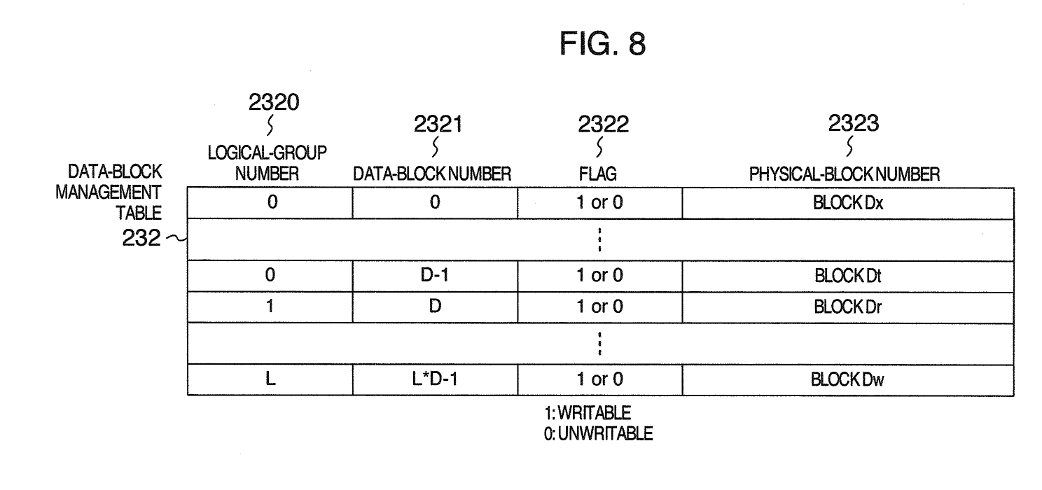

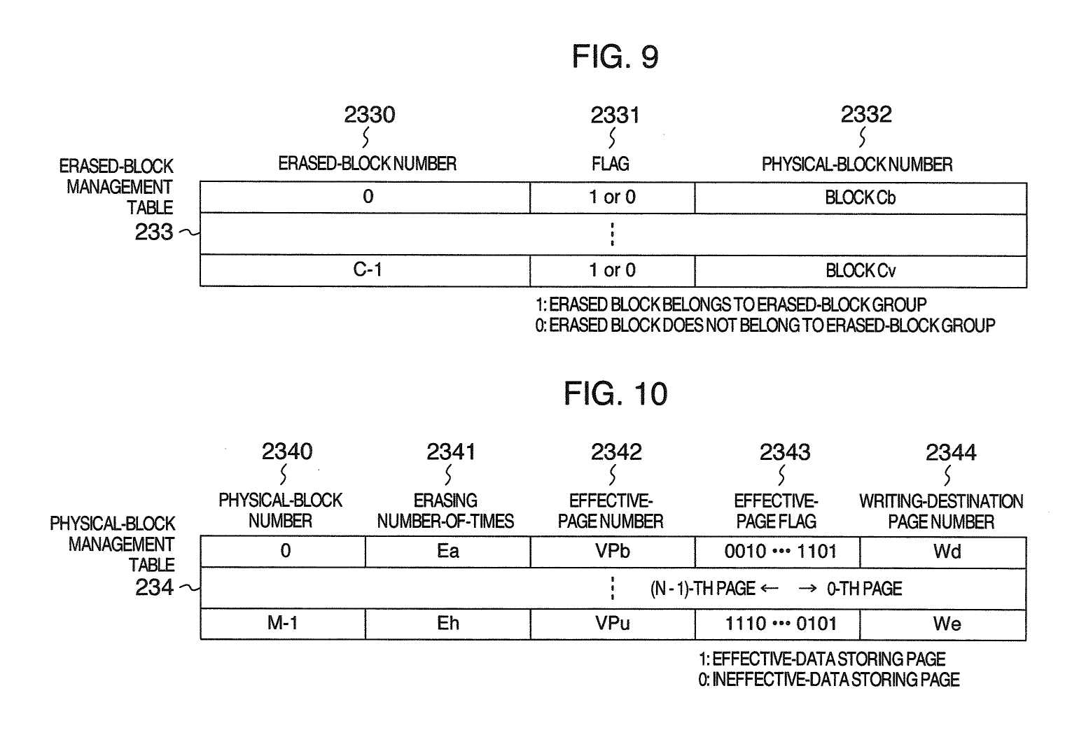

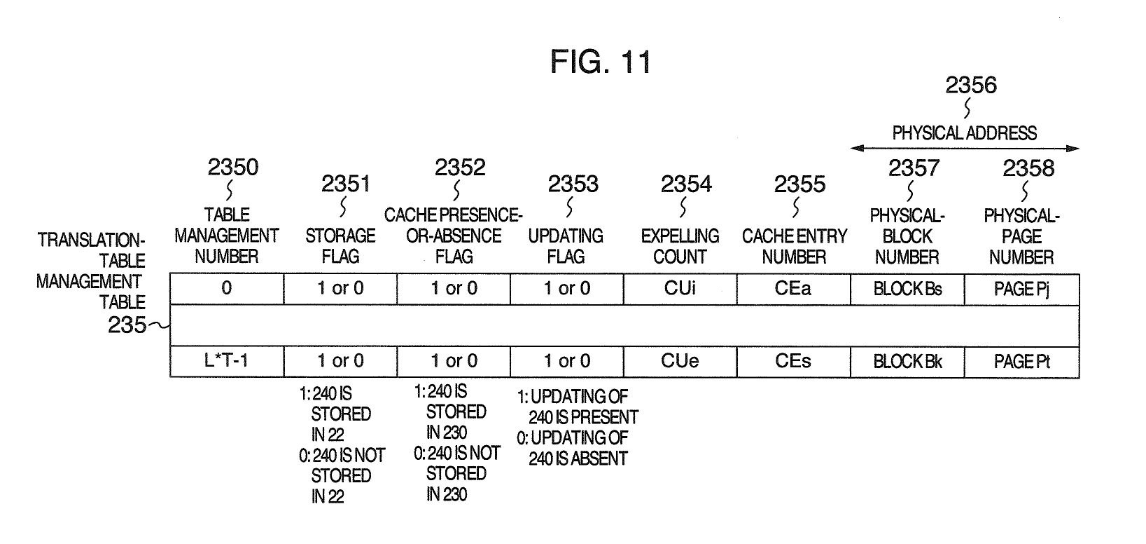

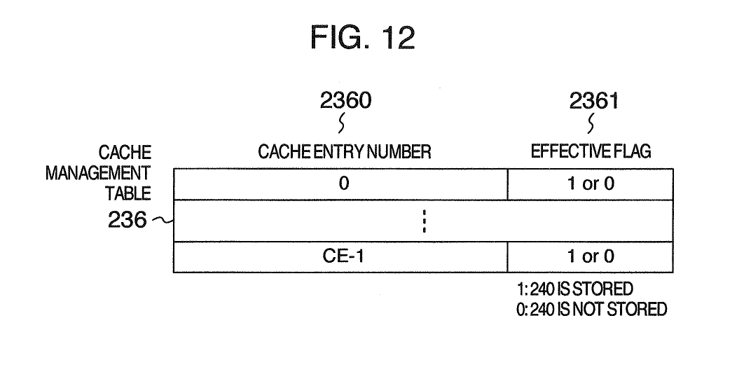

The RAM 23 stores therein a logical-to-physical address translation table cache 230, a scratch-block management table 231 (FIG. 7), a data-block management table 232 (FIG. 8), an erased-block management table 233 (FIG. 9), a physical-block management table 234 (FIG. 10), a translation-table management table 235 (FIG. 11), and a cache management table 236 (FIG. 12).

Incidentally, the logical-to-physical address translation table cache 230 held in the RAM 23 is used for storing a partial content of the logical-to-physical address translation table 220 stored in the nonvolatile memories 22.

This RAM 23 may be a nonvolatile memory such as MRAM (:Magnetic RAM), or may be a volatile memory such as SRAM (:Static RAM) or DRAM (:Dynamic RAM). In the case of using a nonvolatile memory, however, the nonvolatile memory is required to be a one which does not necessitate the data erasing operation at the time of the data rewriting. Also, this RAM 23 may be positioned inside the memory controller 21.

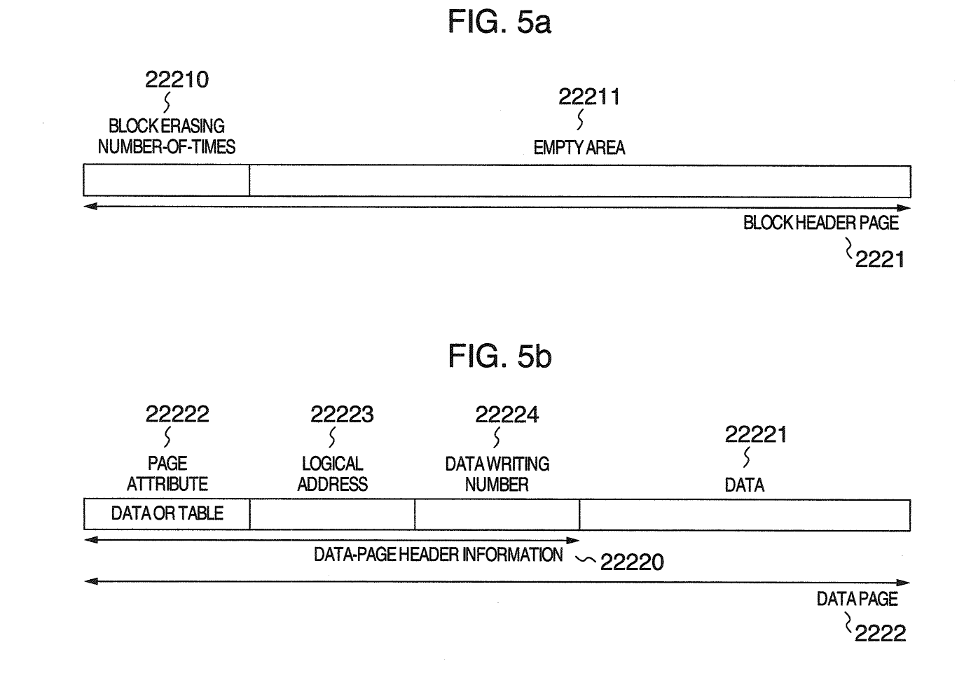

FIG. 2 is a diagram for illustrating the internal configuration of the nonvolatile memory 22. The nonvolatile memory 22 is constituted from the one or more units of erasing data (which are referred to as the blocks 222). Also, each block 222 is constituted from the one or more units of writing data (which are referred to as the pages 2220). In the present embodiment, the number of the blocks 222 of the nonvolatile memory 22 is set at M, and the number of the pages 2220 on each block (222) basis is set at N. Incidentally, types and configurations of the pages 2220 are illustrated in FIG. 5a to FIG. 5c, which will be explained later.

FIG. 3 is a diagram for indicating the utilization state of the nonvolatile memory 22 in the present embodiment. In the present embodiment, the blocks 222 are utilized in such a manner as to be classified into any one of the following three groups: A scratch-block group 223, a data-block group 224, and an erased-block group 225. Accordingly, the total number of the blocks of the three groups, i.e., the scratch-block group 223, the data-block group 224, and the erased-block group 225, is equal to M.

The scratch-block group 223 is constituted from one or more scratch blocks 2230. Each scratch block 2230 is constituted from a block header page 2221, data pages 2222, table pages 2223, and empty pages 2224. However, each scratch block 2230 does not include either of the data pages 2222 and the table pages 2223 in some cases.

The data-block group 224 is constituted from one or more data blocks 2240. Each data block 2240 is constituted from the block header page 2221, the data pages 2222, and the table pages 2223. Like each scratch block 2230, however, each data block 2240 does not include either of the data pages 2222 and the table pages 2223 in some cases. Unlike each scratch block 2230, each data block 2240 does not include the empty pages 2224.

The erased-block group 225 is constituted from one or more erased blocks 2250. Each erased block 2250 is constituted from the block header page 2221 and the empty pages 2224. Each erased block 2250 does not include the data pages 2222 and the table pages 2223.

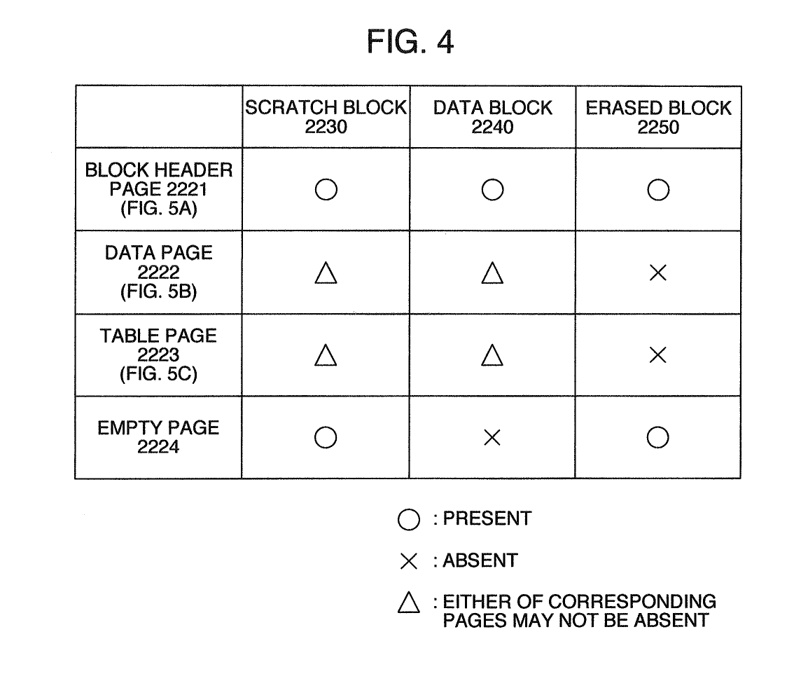

FIG. 4 is a diagram for summarizing the relationship between the blocks and the pages. Each scratch block 2230, each data block 2240, and each erased block 2250 are described in the transverse direction. Each block header page 2221, each data page 2222, each table page 2223, and each empty page 2224 are described in the longitudinal direction. In this drawing, a notation ◯ indicates that the corresponding block includes the corresponding page, and a notation X indicates that the corresponding block does not include the corresponding page. Also, a notation Δ indicates that the corresponding block does not include either of the corresponding pages in some cases. Incidentally, the configurations of each block header page 2221, each data page 2222, and each table page 2223 are illustrated in FIG. 5a to FIG. 5c.

Whatever block 222 included in the nonvolatile memory 22 belongs to any one of the above-described three groups. Moreover, in response to a data writing processing or a block erasing processing, this block 222 transitions its belonging dynamically. Namely, as is illustrated in JP-A-2009-275048 for example, this block 222 performs a dynamical transition of its belonging as follows: A scratch block transitions to a data block. Next, a partial portion of erased blocks is newly allocated to a scratch block. Furthermore, the data block is transitioned to an erased block.

Also, actually, the logical-to-physical address translation table 220 in FIG. 1 is stored in such a manner as to be partitioned into the page unit like the table pages 2223.

FIG. 5a to FIG. 5c are the diagrams for illustrating the data structures in which the data are stored into the pages 2220. As was explained in FIG. 3, there exist the three types of data structures here, i.e., the block header page 2221, the data page 2222, and the table page 2223.

Of these pages, as illustrated in FIG. 5a, the block header page 2221 stores therein at least information on block erasing number-of-times 22210. Although an empty area 22211 is an area into which no information is to be written, this empty area is also allowed to store therein information on a bad-block-indicating flag and error occurrence number-of-times.

As illustrated in FIG. 5b, the data page 2222 stores therein data-page header information 22220 and data 22221. The data-page header information 22220 includes page attribute 22222, logical address 22223, and data writing number 22224.

The page attribute 22222 stores therein a flag which is used when judging whether this page is the data page 2222 or the table page 2223. The logical address 22223 stores therein logical-address information which is assigned by the instruction processing device 4. The data writing number 22224 is a number which is used for judging the newness-or-oldness of the data 22221 if there exist a plurality of data pages (2222) whose logical addresses (22223) are identical to each other.

From the intrinsic point-of-view, the newness-or-oldness of the data 22221 is managed by the respective types of management tables which will be described later. Accordingly, the data writing number 22224 is not absolutely necessary. The presence of the data writing number 22224, however, makes the recovery implementable even if the table information within the RAM is destroyed by some cause or other. Consequently, the number 22224 is described in the present embodiment.

As illustrated in FIG. 5c, the table page 2223 stores therein table-page header information 22230 and logical-to-physical address-translation-table value 22231. The table-page header information 22230 includes page attribute 22232, table management number 22233, and table writing number 22234. Of these factors, the page attribute 22232 is of the same function as the page attribute 22222 in the data page 2222 illustrated in FIG. 5b. Consequently, the explanation of the page attribute 22232 will be omitted here.

The table management number 22233 is the management unit in the translation-table management table 235 illustrated in FIG. 1. A single table management number is allocated to the logical-to-physical address translation table by the amount of the single-page capacity, i.e., a single table page 2223. The presence of the table management number 22233 within the table page 2223 makes it possible to immediately recognize which table-management-number (22233)'s table page 2223 is being copied at the time of the block erasing processing (which will be described later). This advantage makes it possible to facilitate the updating of the translation-table management table 235.

Incidentally, the block erasing processing is the following processing: Namely, if there occurs a shortage of erased blocks, a partial portion of data blocks is transitioned to an erased block. At this time, data stored in the partial portion of the data blocks is copied into a scratch block. Here, it is necessary to manage which pages have been copied.

The table writing number 22234 is a number which is used for judging the newness-or-oldness of the logical-to-physical address-translation-table value 22231 if there exist a plurality of table pages (2223) whose table management numbers (22233) are identical to each other. As is the case with the data writing number 22224, the table writing number 22234 is not absolutely necessary, either. The presence of the table writing number 22234, however, makes the recovery implementable even if the information within the translation-table management table 235 is destroyed by some cause or other. Consequently, the number 22234 is described in the present embodiment.

FIG. 6 is a diagram for indicating the configuration of the logical-to-physical address translation table 220 illustrated in FIG. 1. In FIG. 1, the logical-to-physical address translation table 220 within the nonvolatile memories 22, and the logical-to-physical address translation table cache 230 within the RAM 23 are the tables for managing the data-storing address (i.e., physical address 2203) which corresponds to an address (i.e., logical address 2202) specified by the instruction processing device 4.

On account of these circumstances, the logical-to-physical address translation table 220 illustrated in FIG. 6 stores therein the logical address 2202 and the physical address 2203 in a manner of being paired with each other. Of these addresses, the physical address 2203, which defines the storage location of the in-memory data, is represented by the combination of physical-block number 2204 and physical-page number 2205.

Also, table management number 2201 and logical-group number 2200 are assigned for each combination of the logical address 2202 and the physical address 2203. As is the case with the table management number 22233 (refer to FIG. 5c) in the table page 2223, the table management number 2201 indicates the management number in the translation-table management table 235 (FIG. 1). The tables which are created by partitioning the logical-to-physical address translation table 220 in the unit of this table management number 2201 will be referred to as “partitioned translation tables 240” hereinafter. In the example in FIG. 6, the portion which is surrounded by a thick black line within the logical-to-physical address translation table 220 turns out to be a single partitioned translation table 240. Also, the spaces which are created by partitioning the logical-address space in accordance with a constant proportion are illustrated as the logical-group number 2200.

In the logical-to-physical address translation table 220 in FIG. 6, the logical-group number 2200 and the table management number 2201 are arranged neatly in an ascending order. The actual logical-to-physical address translation table 220, however, is partitioned for each table page 2223. As a result, the numbers 2200 and 2201 therein are not necessarily arranged into such a neat arrangement. Also, the swapping of the table information occurs between the logical-to-physical address translation table 220 and the logical-to-physical address translation table cache 230. As a result, in the logical-to-physical address translation table cache 230 as well, the logical-group number 2200 and the table management number 2201 are not necessarily arranged neatly in an ascending order as are illustrated in FIG. 6.

FIG. 7 is a diagram for indicating the configuration of the scratch-block management table 231 illustrated in FIG. 1. The scratch-block management table 231 is a table for managing the scratch blocks 2230 (FIG. 3) one or more of which are allocated for each logical-group number 2310. Each scratch block 2230 is managed by scratch-block number 2311. Moreover, a flag 2312 for indicating the utilization state of each scratch block 2230, and the corresponding physical-block number 2313 are assigned thereto. If data is writable into this scratch block 2230, the utilization-state indicating flag 2312 indicates “1”. Meanwhile, if the empty pages are absent and thus data is unwritable therein, the flag 2312 indicates “0”.

FIG. 8 is a diagram for indicating the configuration of the data-block management table 232 illustrated in FIG. 1. The data-block management table 232 is a table for managing the data blocks 2240 (FIG. 3) one or more of which are allocated for each logical-group number 2320. Each data block 2240 is managed by data-block number 2321. Moreover, a flag 2322 for indicating the utilization state of each data block 2240, and the corresponding physical-block number 2323 are assigned thereto. If data is readable from this data block 2240, the utilization-state indicating flag 2322 indicates “1”. Meanwhile, if this data block has been erased already, the flag 2322 indicates “0”.

FIG. 9 is a diagram for indicating the configuration of the erased-block management table 233 illustrated in FIG. 1. The erased-block management table 233 is a table for managing the erased blocks 2250 whose data have been erased. Each erased block 2250 (FIG. 3) is managed by erased-block management number 2330. Moreover, a flag 2331 for indicating the utilization state of each erased block, and the corresponding physical-block number 2332 are assigned thereto. If this erased block belongs to the erased-block group, the utilization-state indicating flag 2331 indicates “1”. Meanwhile, if this erased block's belonging is changed from the erased-block group, the flag 2331 indicates “0”. Here, this change is caused to occur by such a processing as this erased block's being allocated as a new scratch block 2230.

FIG. 10 is a diagram for indicating the configuration of the physical-block management table 234 illustrated in FIG. 1. The physical-block management table 234 manages the utilization situation of each block 2220. Each block 2220 is managed by physical-block number 2340. Plural pieces of information which are held in the table 234 on each block basis are as follows: Erasing number-of-times 2341, effective-page number 2342, effective-page flag 2343, and writing-destination page number 2344.

The erasing number-of-times 2341 indicates the number-of-times in which this block has been erased.

The effective-page number 2342 indicates the number of pages which store effective data within the block. Also, the effective-page flag 2343 indicates the position of a page which stores the effective data. The effective-data storing page is represented by “1”, and an ineffective-data storing page is represented by “0”. The rightmost bit of the effective-page flag 2343 represents the 0-th page, and the leftmost bit thereof represents the (N−1)-th page.

The writing-destination page number 2344 indicates a page number which is writable next. If this block belongs to the data-block group 224, and if a writable page is absent, the writing-destination page number becomes equal to N.

FIG. 11 is a diagram for indicating the configuration of the translation-table management table 235 illustrated in FIG. 1. The translation-table management table 235 manages the partitioned translation tables 240 (illustrated in FIG. 6) on each table-management-number (2350) basis. Information held in the translation-table management table 235 for each table management number 2350 are as follows: Storage flag 2351, cache presence-or-absence flag 2352, updating flag 2353, expelling count 2354, cache entry number 2355, and physical address 2356.

Of these plural pieces of information, the storage flag 2351 is a flag for indicating whether or not the partitioned translation table 240 of this table management number 2350 is stored in the nonvolatile memories 22. If the partitioned translation table 240 has been already stored in the nonvolatile memories 22, the flag 2351 indicates “1”. Meanwhile, if the table 240 has been not yet stored therein, the flag 2351 indicates “0”.

The cache presence-or-absence flag 2352 is a flag for indicating whether or not the partitioned translation table 240 of this table management number 2350 is stored in the logical-to-physical address translation table cache 230. If the partitioned translation table 240 is stored therein, the flag 2352 indicates “1”. Meanwhile, if the table 240 is not stored therein, the flag 2352 indicates “0”.

The updating flag 2353 is a flag for indicating that, if this partitioned translation table 240 is held in the logical-to-physical address translation table cache 230, the table information stored in this partitioned translation table 240 is updated. If the table information is updated by such a processing as a request from the instruction processing device 4, the flag 2353 indicates “1”. Meanwhile, if the table information is not updated, the flag 2353 indicates “0”. Namely, taking advantage of the updating flag 2353 makes it possible to make the judgment as to the presence or absence of the updating. This judgment completely prevents a not-updated partitioned translation table 240 from being written into the nonvolatile memories 22, thereby suppressing a lowering in the processing speed.

The expelling count 2354 is information which, if the capacity of the logical-to-physical address translation table cache 230 becomes fully-occupied, is used for determining which of the partitioned translation tables 240 should be written into the nonvolatile memories 22. Although, in the present embodiment, the LRU (:Least Recently Used) scheme is used for the table's expelling from the logical-to-physical address translation table cache 230, some other scheme is also usable. When using some other scheme, the expelling count 2354 may be excluded.

The cache entry number 2355 indicates the storage destination of the partitioned translation table 240 on the logical-to-physical address translation table cache 230.

The physical address 2356 indicates the storage destination of the partitioned translation table 240 on the nonvolatile memories 22. The physical address 2356 is constituted from the combination of physical-block number 2357 and physical-page number 2358.

In the case of an ordinary data cache, the cache holds therein only the information by the amount of the cache's entry. If, however, basically the same management method is assumed and employed in the present embodiment as well, this management method makes it impossible to execute a processing of reading the information stored in the partitioned translation table 240 from the nonvolatile memories 22 into the logical-to-physical address translation table cache 230. On account of this circumstance, regardless of whether or not the partitioned translation table 240 is stored in the logical-to-physical address translation table cache 230, the information stored in all of the partitioned translation tables 240 are held in the translation-table management table 235. Also, in order to recognize which table-management-number (2350)'s table information is held in the logical-to-physical address translation table cache 230, the information stored in the cache presence-or-absence flag 2352 is stored into the translation-table management table 235.

FIG. 12 is a diagram for indicating the configuration of the cache management table 236 illustrated in FIG. 1. The cache management table 236 manages the entry of the logical-to-physical address translation table cache 230 on each cache-entry-number (2360) basis. The cache management table 236 holds an effective flag 2361 for each cache entry number 2360.

The effective flag 2361 is a flag for indicating whether or not the partitioned translation table 240 is stored in the corresponding cache entry number 2360. If the partitioned translation table 240 is stored therein, the flag 2361 indicates “1”. Meanwhile, if the table 240 is not stored therein, the flag 2361 indicates “0”.

The respective tables stored in the nonvolatile memories 22 and the RAM 23 are configured as described above. In the present invention, of these table configurations, the special ingenuities are given to, in particular, the logical-to-physical address translation table 220 illustrated in FIG. 6, the translation-table management table 235 illustrated in FIG. 11, and the cache management table 236 illustrated in FIG. 12.

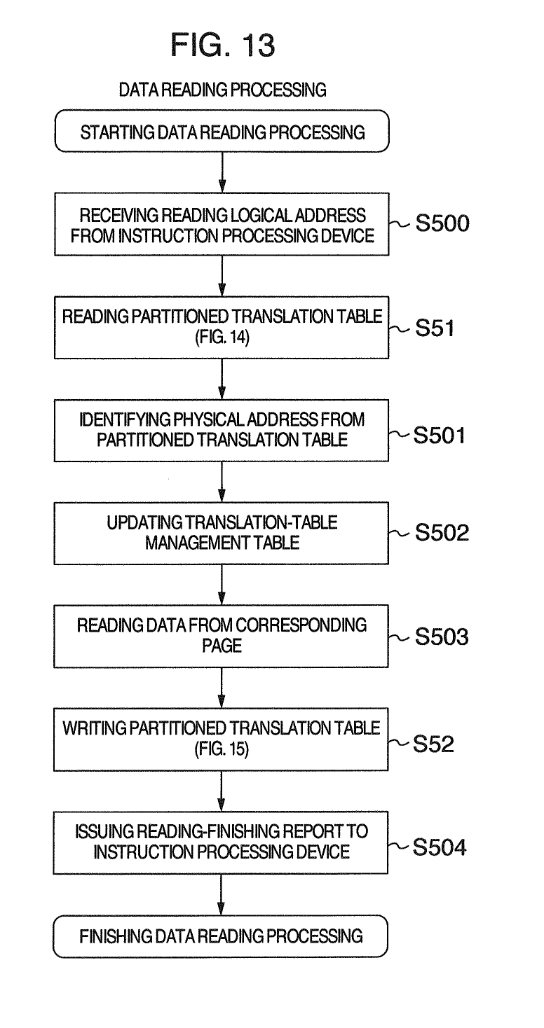

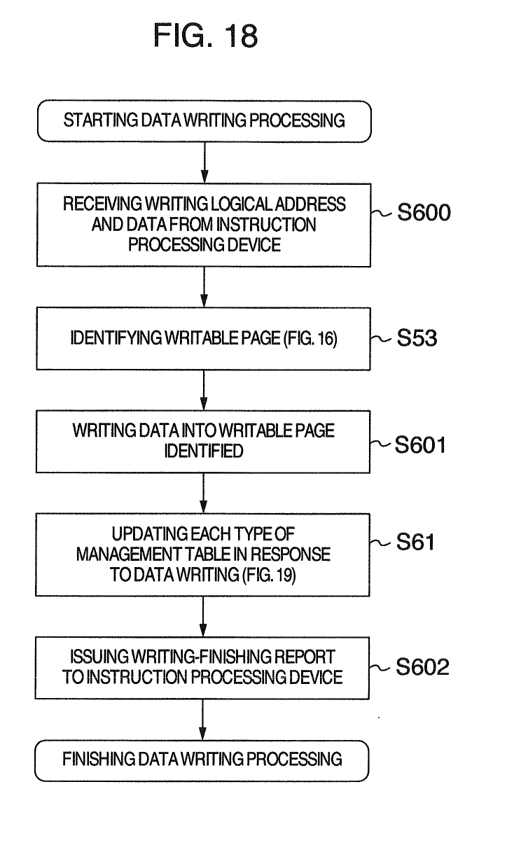

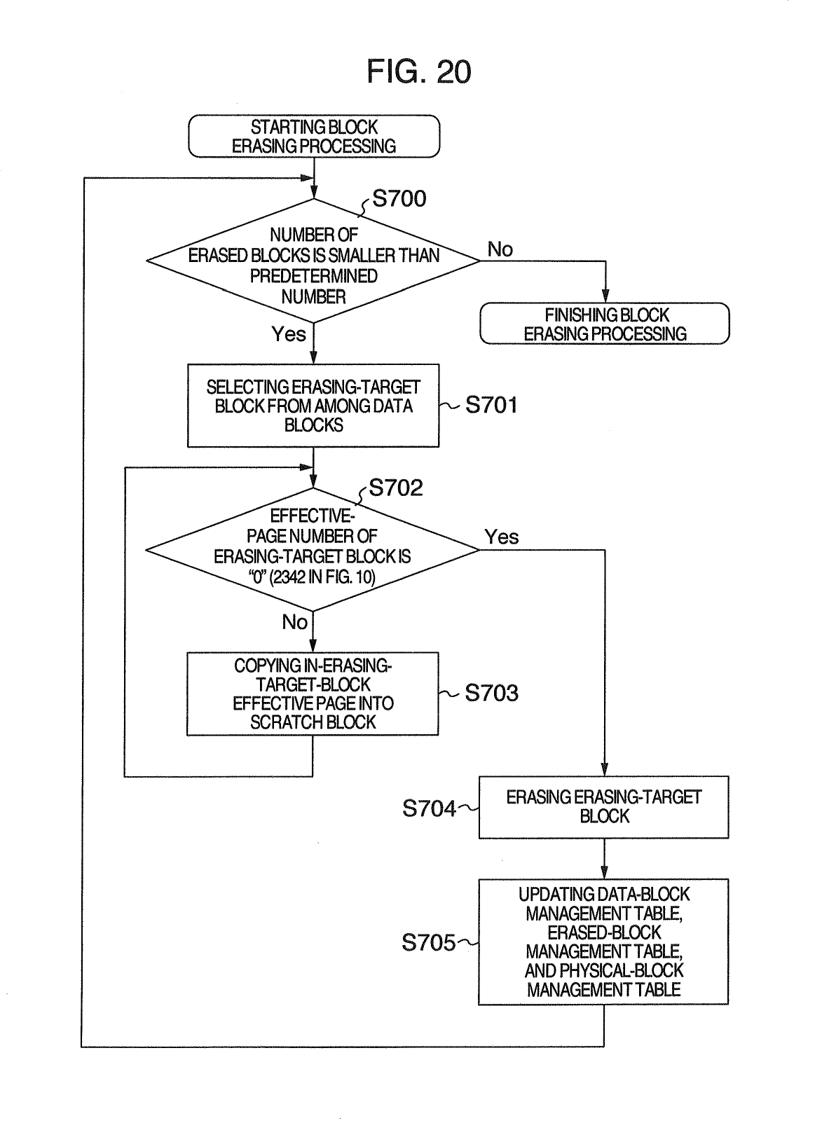

Taking advantage of the tables like this, the data reading processing is executed based on a processing flowchart illustrated in FIG. 13. Also, the data writing processing is executed based on a processing flowchart illustrated in FIG. 18. Furthermore, the block erasing processing is executed based on a processing flowchart illustrated in FIG. 20. Incidentally, these processings are executed by the memory controller 21 in the storage device 2.

### [Data Reading Processing]

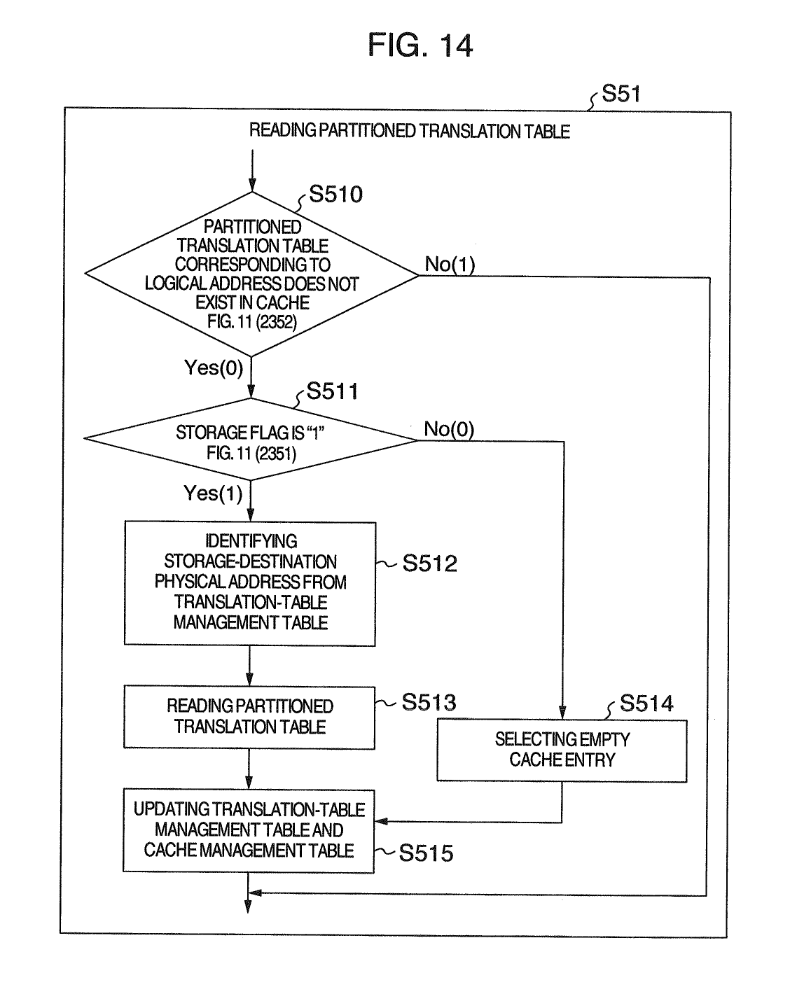

FIG. 13 is a diagram for illustrating the processing flowchart at the time of a data reading processing. Also, FIG. 14 to FIG. 17 will be used for giving the detailed explanation of each step illustrated in FIG. 13.

In FIG. 1, a data reading processing is started in response to a trigger that the instruction processing device 4 specifies the logical address until hereeading target.

In the flowchart illustrated in FIG. 13, at a step S500, the memory controller 21 in the storage device 2 receives the logical address of the reading target from the instruction processing device 4 via the data bus 3 and the I/F control unit 20.

Next, at a step S51, the memory controller 21 confirms whether or not the partitioned translation table 240 (FIG. 6) corresponding to the above-described logical address exists on the logical-to-physical address translation table cache 230. Then, if the partitioned translation table 240 does not exist thereon, the memory controller 21 performs a processing of reading the partitioned translation table 240 from the nonvolatile memories 22. The details of the reading processing at this step S51 will be described later, using FIG. 14.

As a result of the processing at the step S51, the partitioned translation table (240) corresponding to the specified logical address has been acquired on the logical-to-physical address translation table cache 230. In this case, at the next step S501, the memory controller 21 identifies the physical address corresponding to the above-described logical address, using the partitioned translation table 240 on the logical-to-physical address translation table cache 230. Since the partitioned translation table 240 has the configuration illustrated in FIG. 6, the combination of the physical-block number 2204 and the physical-page number 2205 is acquired as the physical address 2203.

Next, at a step S502, in the translation-table management table 235 illustrated in FIG. 11, the memory controller 21 changes, to “0”, the expelling count 2354 of the partitioned translation table (240) which is used at the step S501. Also, in partitioned translation tables (240) other than the above-described partitioned translation table 240, the memory controller 21 increments, by 1, the expelling count 2354 of a partitioned translation table (240) whose cache presence-or-absence flag 2352 is “1”. if the capacity of the logical-to-physical address translation table cache 230 becomes fully-occupied by the series of processings at the step S502, the memory controller 21 returns and writes the partitioned translation tables 240 into the nonvolatile memories 22 in accordance with an order starting from the earliest partitioned translation table 240 (i.e., the number of the expelling count 2354 of which is the largest). This operation makes it possible to maintain the capacity of the logical-to-physical address translation table cache 230 at a constant value.

After that, at a step S503, the memory controller 21 reads the data 221 from the nonvolatile memories 22, using the physical address identified at the step S501.

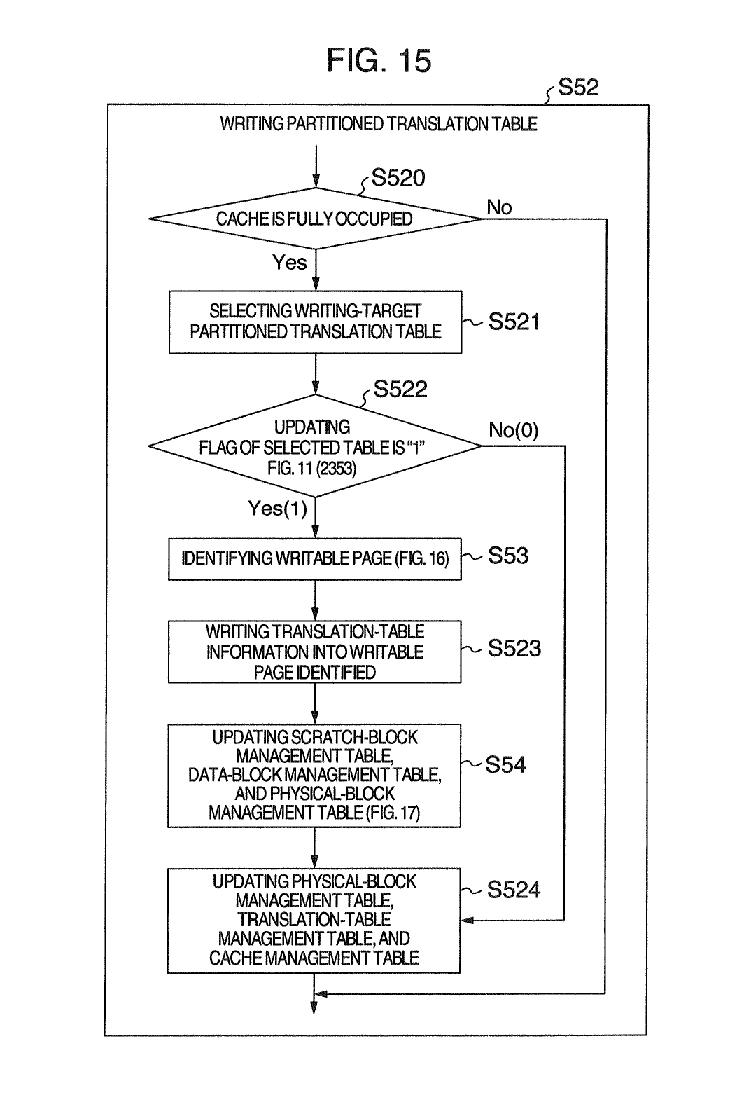

Next, at a step S52, if the capacity of the logical-to-physical address translation table cache 230 is fully occupied, the memory controller 21 performs a processing of writing the partitioned translation table 240 into the nonvolatile memories 22. The details of the writing processing at this step S52 will be described later, using FIG. 15.

Finally, at a step S504, the memory controller 21 issues a reading-finishing report to the instruction processing device 4.

The explanation given until here is the outline of the data reading processing. The step S51 and the step S52, however, can be segmentalized further. Accordingly, the explanation will be further given below concerning these segmentalized processings. FIG. 14 is a diagram for illustrating the detailed processing flowchart at the step S51. This detailed processing is a processing for reading the logical-address-corresponding partitioned translation table 240 from the nonvolatile memories 22.

At the step S51, first, at a step S510, it is confirmed whether or not the logical-address-corresponding partitioned translation table (240) received from the instruction processing device 4 is held in the logical-to-physical address translation table cache 230. This confirmation is performed using the cache presence-or-absence flag 2352 stored in the translation-table management table 235 illustrated in FIG. 11. Then, if the cache presence-or-absence flag 2352 is “0”, the partitioned translation table 240 is not stored in the logical-to-physical address translation table cache 230. Accordingly, the processing transfers to a processing at a step S511. Meanwhile, if the cache presence-or-absence flag 2352 is “1”, the table 240 is stored in the logical-to-physical address translation table cache 230. Consequently, the processing at the step S51 is finished.

At the step S511, subsequently, it is confirmed whether or not the storage flag 2351 stored in the translation-table management table 235 in FIG. 11 is “1”(i.e., the partitioned translation table 240 has been stored in the nonvolatile memories 22). Then, if the storage flag 2351 is “1”, a processing at a step S512 is executed. Meanwhile, if the storage flag 2351 is “0”, a processing at a step S514 is executed.

If the storage flag 2351 is “1”, at the step S512, the physical address 2356, i.e., the storage destination of this partitioned translation table 240, is confirmed using FIG. 11.

At a step S513, the partitioned translation table (240) corresponding to the physical address 2356 is read from the nonvolatile memories 22. Moreover, the effective flag 2361 stored in the cache management table 236 in FIG. 12 is confirmed. Then, based on this confirmation, the information in the partitioned translation table (240) read from the nonvolatile memories 22 is stored into an empty entry of the logical-to-physical address translation table cache 230.

Incidentally, if, at the step S511, the storage flag 2351 is “0”, the effective flag 2361 stored in the cache management table 236 in FIG. 12 is confirmed at the step S514. Then, based on this confirmation, an empty entry of the logical-to-physical address translation table cache 230 is selected.

After that, at a step S515, the cache presence-or-absence flag 2352 stored in the translation-table management table 235 in FIG. 11 is changed to “1”. Moreover, the updating flag 2353 and the expelling count 2354 are initialized into “0”. Furthermore, the cache entry number 2355 is updated to the entry number selected at the step S513 or the step S514. Also, in the cache management table 236 in FIG. 12, the effective flag 2361 corresponding to the above-described cache entry number 2355 is changed to “1”. The explanation given until here is the details of the processing at the step S51.

FIG. 15 is a diagram for illustrating the detailed processing flowchart at the step S52. This entire processing at the step S52 is a processing for writing the partitioned translation table 240 into the nonvolatile memories 22.

At the first step S520 at the step S52, at first, it is confirmed whether or not the capacity of the logical-to-physical address translation table cache 230 is fully occupied. Then, if the capacity is fully occupied (:Yes), the processing transfers to the side of a step S522, thereby performing the processing for writing the partitioned translation table 240 into the nonvolatile memories 22. Meanwhile, if the capacity is not fully occupied (:No), the processing at the step S52 is finished.

In the case of writing the partitioned translation table 240 into the nonvolatile memories 22, at first, at a step S521, reference is made to the cache presence-or-absence flag (2352) and the expelling count (2354) which are stored in the translation-table management table 235 illustrated in FIG. 11. Moreover, of the partitioned translation tables (240) whose cache presence-or-absence flags 2352 are “1”(i.e., the tables 240 are stored in the nonvolatile memories 22), a partitioned translation table (240) whose expelling count 2354 is the largest is selected as a writing target.

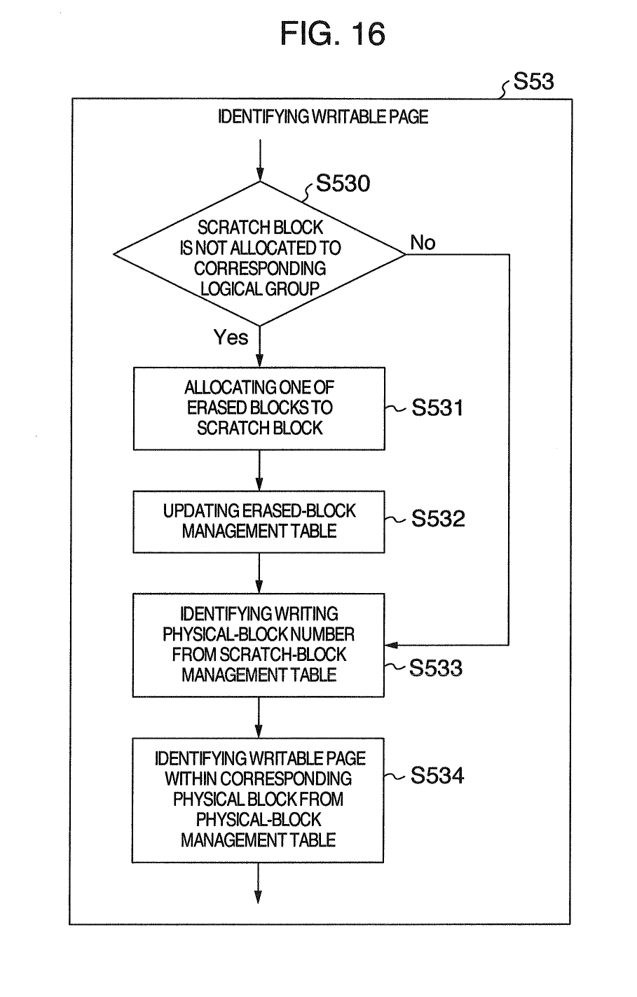

After that, at a step S522, the updating flag 2353 (FIG. 11) of the selected writing-target partitioned translation table 240 is confirmed. Then, if the updating flag 2353 is “1” (i.e., the updating of 240 is present), the processing transfers to a step S53. At this step S53, the identification of a writing-destination page will be performed. Meanwhile, if the updating flag 2353 is “0” (i.e., the updating of 240 is absent), the processing transfers to a step S524. Incidentally, the details of the processing at the step S53 will be described later, using FIG. 16.

At a step S523, the selected writing-target partitioned translation table 240 is written into the physical address which is identified at the step S53.

Furthermore, at a step S54, the update processings of the scratch-block management table 231 in FIG. 7, the data-block management table 232 in FIG. 8, and the physical-block management table 234 in FIG. 10 are performed after the writing processing has been finished.

Finally, at the step S524, from the physical address 2356 stored in the translation-table management table 235 (FIG. 11) before the writing processing is performed, the physical-block number 2340, which is stored in the physical-block management table 234 in FIG. 10, and which corresponds to the physical address 2356, is selected. Moreover, the effective-page number 2342 is decremented by 1, and the corresponding-page portion of the effective-page flag 2343 is updated to “0”.

Also, in the translation-table management table 235 (FIG. 11), the storage flag 2351 corresponding to the table management number 2350 of the table (240) whose writing has been performed is changed to “1” (i.e., the table 240 is stored into the nonvolatile memories 22). Furthermore, the cache presence-or-absence flag 2352 is changed to “0” (i.e., the table 240 is not stored into the logical-to-physical address translation table cache 230). Also, the portion of the physical address 2356 in FIG. 11 is updated to the physical address of the writing destination of the nonvolatile memories 22.

In addition, reference is made to the cache entry number 2355 (FIG. 11) of the partitioned translation table (240) whose writing has been performed. Then, in the cache management table 236 in FIG. 12, the effective flag 2361 of the cache entry number 2360 corresponding to the cache entry number 2355 is changed to “0”(i.e., the partitioned translation table 240 is not stored).

Incidentally, if, at the step S522, the updating flag 2353 is “0” (i.e., the updating of 240 is absent), the processings at the step S53, the step S523, and the step S54 are not performed. Also, at the step S524 as well, the updating of the physical-block management table 234 (FIG. 10), and the updating of the physical address 2356 in the translation-table management table 235 (FIG. 11) are not performed. The explanation given until here is the details of the processing at the step S52.

The step S53 and the step S54, i.e., the main processings within the step S52, can be segmentalized further.

FIG. 16 is a diagram for illustrating the detailed processing flowchart at the step S53. At the first step S530 at the step S53, at first, it is confirmed whether or not the scratch block 2230 (FIG. 3) is allocated to the logical-group number 2200 to which the writing-target partitioned translation table 240 (FIG. 6) belongs. This confirmation is performed by judging, in the scratch-block management table 231 (FIG. 7), the value of the flag 2312 belonging to the logical-group number 2310 which coincides with the logical-group number 2200. Then, if the flag 2312 is “1” (i.e., writable), it is judged that the scratch block 2230 has been allocated already. Meanwhile, if the flag 2312 is “0” (i.e., unwritable), it is judged that the scratch block 2230 has been not allocated. If the scratch block 2230 has been allocated already, the processing transfers to a step S533.

Meanwhile, if the scratch block 2230 has been not allocated, at a step S531, a single erased block 2250 is selected from among the erased blocks 2250 illustrated in FIG. 3. Then, the single erased block 2250 selected is registered into the portion of the physical-block number 2313 stored in the scratch-block management table 231 in FIG. 7. Moreover, the flag 2312 is changed to “1” (i.e., writable).

After that, at a step S532, with respect to the erased block (2250) which is illustrated in FIG. 3, and which is allocated to the scratch block, the flag 2331 stored in the erased-block management table 233 in FIG. 9 is changed to “0” (i.e., the erased block 2250 does not belong to the erased-block group).

Next, at a step S533, the scratch-block management table 231 in FIG. 7 is confirmed, thereby confirming the physical-block number 2313 corresponding to the scratch-block number 2311.

Furthermore, at a step S534, the physical-block number (2313) confirmed at the step S533 is compared with the physical-block number (2340) stored in the physical-block management table 234 in FIG. 10. As a result, the writing-destination page number 2344 of the corresponding physical block is acquired. The processing at the step S53 is completed until here.

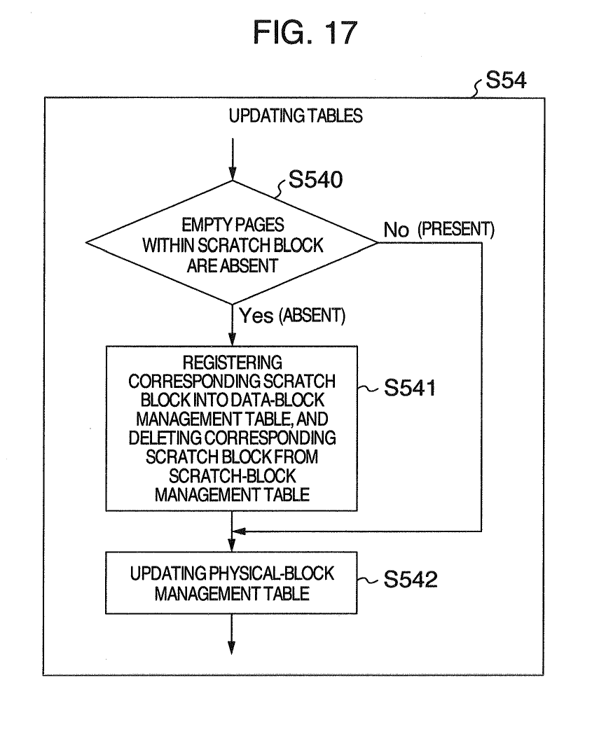

Also, FIG. 17 is a diagram for illustrating the detailed processing flowchart at the step S54. At the first step S540 at the step S54, at first, it is confirmed whether or not the empty pages included in the scratch block 2230 in FIG. 3 are lost by the writing of the partitioned translation table 240. Then, if the empty pages are absent, the processing enters a step S541. Meanwhile, if the empty pages are present, the processing transfers to a step S542.

If the empty pages are lost, at the step S541, the following series of processings are executed: First, in the scratch-block management table 231 illustrated in FIG. 7, the flag 2312 of this scratch block is changed to “0” (i.e., unwritable). After that, in the data-block management table 232 illustrated in FIG. 8, of the logical-group numbers (2320) corresponding to the logical-group number (2310) to which this scratch block has belonged, the data-block number (2321) whose flag 2322 is “0” (i.e., unreadable) is selected. Moreover, the flag 2322 of the selected data-block number 2321 is changed to “1” (i.e., readable). Furthermore, the physical-block number 2313 of the above-described scratch block is registered into the portion of the physical-block number 2323.

Meanwhile, if the empty pages are present in the scratch block, the processing at the step S541 is not performed. After the step S541 or the step S540, at the step S542, the effective-page number 2342 and the writing-destination page number 2344 stored in the physical-block management table 234 in FIG. 10 are incremented by 1, thereby updating the effective-page flag 2343. The processing at the step S54 is finished until here.

### [Data Writing Processing]

FIG. 18 is a diagram for illustrating the processing flowchart at the time of a data writing processing. Partially, there exist processings which have the same step-S numbers as the ones at the time of the data reading processing. Since the processing contents are also the same in these processings, the explanation thereof will be omitted here.

A data writing processing is started in response to a trigger that, at a step S600, the memory controller 21 receives writing data and its writing logical address from the instruction processing device 4 via the data bus 3 and the I/F control unit 20.

Next, at the step S53, the memory controller 21 performs the identification of a physical address into which the writing data is to be written. Since this processing has been explained in detail in FIG. 16, the explanation thereof will be omitted here.

After that, at a step S601, the memory controller 21 writes the data into the physical address which is identified at the step S53.

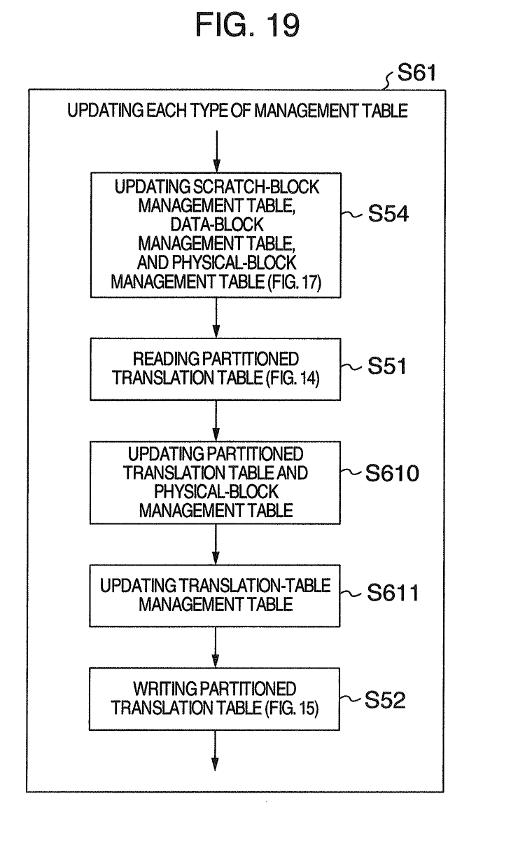

Next, at a step S61, the memory controller 21 performs the updating of each type of management table after having finished the writing. This updating processing will be described later, using FIG. 19.

Finally, at a step S602, the memory controller 21 issues a writing-finishing report to the instruction processing device 4.

The explanation given until here is the outline of the data writing processing. The step S61, however, can be segmentalized further. Accordingly, the explanation will be further given below concerning these segmentalized processings. FIG. 19 is a diagram for illustrating the detailed processing flowchart at the step S61.

At the step S61, first, at the step S54, the update processings of the scratch-block management table 231, the data-block management table 232, and the physical-block management table 234 are performed in response to the data writing processing. Since these update processings have been explained in detail in FIG. 17, the explanation thereof will be omitted here.

Next, at the step S51, the reading processing of the partitioned translation table 240 is performed. Since this reading processing has been explained in detail in FIG. 14, the explanation thereof will be omitted here.

Next at a step S610, the before-writing physical address corresponding to the writing logical address is identified from the partitioned translation table 240 (FIG. 6) on the logical-to-physical address translation table cache 230 in FIG. 1. Moreover, using this before-writing physical address, the effective-page number 2342 is decremented, and the effective-page flag 2343 is made ineffective in the physical-block management table 234 (FIG. 10). Also, the portion of the physical address 2203 stored in the partitioned translation table 240 (FIG. 6) is rewritten into the physical address which is identified at the step S53 illustrated in FIG. 18.

After that, at a step S611, in the translation-table management table 235 in FIG. 11, an expelling count 2354 is changed to“0”. Here, this expelling count 2354 corresponds to the table management number 2350 of the partitioned translation table 240 which is updated at the step S610. Also, in expelling counts 2354 other than the above-described expelling count 2354, the expelling count 2354 of the table management number (2350) whose cache presence-or-absence flag 2352 is “1” is incremented by 1.

After that, at the step S52, the writing processing of the partitioned translation table 240 is performed. Since this writing processing has been explained in detail in FIG. 15, the explanation thereof will be omitted here.

The explanation given until here is the details of the processing at the step S61.

### [Block Erasing Processing]

FIG. 20 is a diagram for illustrating the processing flowchart at the time of a block erasing processing. First of all, at a step S700, if the number of the erased blocks 2250 in FIG. 3 becomes smaller than a predetermined constant number, the memory controller 21 in FIG. 1 starts the block erasing processing.

Then, at a step S701, the memory controller 21 makes reference to the data-block management table 232 in FIG. 8, thereby acquiring the physical-block number 2323 registered therein. Moreover, in the physical-block management table 234 in FIG. 10, the memory controller 21 makes reference to the effective-page number 2342 of the physical-block number 2340 which corresponds to the physical-block number 2323 acquired. Furthermore, of blocks registered in the data-block management table 232, the memory controller 21 selects, as the erasing target, a block whose effective-page number is the smallest.

Next, at a step S702, the memory controller 21 confirms whether or not the effective-page number 2342 of the block selected as the erasing target is “0”.

If the effective-page number 2342 is not“0”, at a step S703, the memory controller 21 makes reference to the effective-page flag 2343 stored in the physical-block management table 234 (FIG. 10). Moreover, the memory controller 21 copies, into the scratch block 2230, effective-page data which is stored in the effective-page flag 2343.

The memory controller 21 repeats this copy operation until the effective-page number 2342 of the selected block becomes equal to “0”. When the effective-page number 2342 becomes equal to “0”, the memory controller 21 transfers to a step S704. At this step S704, the memory controller 21 erases the erasing-target block.

Finally, at a step S705, the memory controller 21 executes a series of updating processings of each type of management table. First, in the data-block management table 232 in FIG. 8, the memory controller 21 changes, to “0” (i.e., unreadable), the flag 2322 of the physical-block number 2323 which coincides with the erased-block number. By going this, the memory controller 21 deletes the registration of this block from the data-block management table 232. Moreover, in the erased-block management table 233 in FIG. 9, the memory controller 21 registers the erased-block number into the entry of the erased-block number 2330 whose flag 2331 is “0” (i.e., the erased block does not belong to the erased-block group). Furthermore, the memory controller 21 changes the flag 2331 to “1” (i.e., the erased block belongs to the erased-block group). Also, in the physical-block management table 234 in FIG. 10, the memory controller 21 increments, by 1, the erasing number-of-times 2341 of the physical-block number 2340 corresponding to the erased-block number.

The above-described block erasing processing illustrated in FIG. 20 is repeated until the number of the erased blocks 2250 becomes larger than the predetermined constant number. The explanation given until here is the processing at the time of the block erasing.

Incidentally, the present invention is not limited to the above-described embodiments, but includes a variety of modified embodiments. For example, in the above-described embodiments, the detailed explanation has been given in order to explain the present invention in an easy-to-understand manner. Accordingly, the present invention is not necessarily limited to the embodiments which are equipped with all of the configurations explained.

Also, a partial element or the entire element of each configuration, each function, each processing unit, and each processing method described above may be implemented using such hardware as, e.g., being designed with integrated circuits. Also, each configuration and each function described above may be implemented with software in such a manner that a processor interprets and executes a program for implementing each function.

Also, the control lines and information lines are only limited to the ones which are conceivable as being necessary when seen from the explanation's point-of-view. Consequently, all of control lines and information lines are not necessarily specified when seen from the commercial product's point-of-view. Actually, it is allowable to conceive that almost all of the configurations are connected to each other.

It should be further understood by those skilled in the art that although the foregoing description has been made on embodiments of the invention, the invention is not limited thereto and various changes and modifications may be made without departing from the spirit of the invention and the scope of the appended claims.

1. A storage device, comprising:
a nonvolatile memory which includes pages and blocks, each of the pages being a predetermined unit of writing data, each of the blocks being a unit of erasing data which is larger than the unit of writing data in size;
a RAM which is capable of performing data reading/writing processings therefrom/therein; and
a memory controller for performing the data reading/writing processings from/into the nonvolatile memory and the RAM, wherein
the nonvolatile memory stores data and a plurality of partitioned translation tables, the writing processing of the data being performed into the nonvolatile memory by an instruction processing device, the plurality of partitioned translation tables being created by partitioning, in the page unit, a logical-to-physical address translation table for managing storage locations of the data,
the RAM storing a logical-to-physical address translation table cache for storing at least the one or more partitioned translation tables, a translation-table management table for managing the partitioned translation tables, and a cache management table for managing the logical-to-physical address translation table cache,
the translation-table management table storing a cache presence-or-absence flag and a cache entry number, the cache presence-or-absence flag being used for indicating that the partitioned translation tables are stored into the logical-to-physical address translation table cache, the cache entry number being used for indicating storage destinations of the partitioned translation tables in the logical-to-physical address translation table cache,
reading/writing processings for the information in the logical-to-physical address translation table between the nonvolatile memory and the RAM being performed in the page unit.

2. The storage device according to claim 1, wherein,
when the plurality of partitioned translation tables are stored in the logical-to-physical address translation table cache, it is determined based on an expelling count which of the partitioned translation tables should be written from the logical-to-physical address translation table cache into the nonvolatile memory, the expelling count being used for indicating utilization frequencies of the partitioned translation tables.

3. The storage device according to claim 1, wherein,
if information stored in a partitioned translation table coincides with information stored in the partitioned translation tables in the nonvolatile memory, writing processing of the partitioned translation table into the nonvolatile memory is not performed, the partitioned translation table being selected as a writing target of the writing processing, and being stored in the logical-to-physical address translation table cache.

4. The storage device according to claim 1, wherein
storage area of the nonvolatile memory is constituted from one or more scratch blocks, one or more data blocks, and one or more erased blocks,
the RAM further storing a scratch-block management table for performing management of the scratch blocks, a data-block management table for performing management of the data blocks, and an erased-block management table for performing management of the erased blocks,
when the partitioned translation tables stored in the logical-to-physical address translation table cache are written into the nonvolatile memory, the partitioned translation tables being written into empty pages included in one of the scratch blocks, and the translation-table management table being updated, and,
if the empty pages included in the one scratch block are occupied and lost, the scratch block being addressed as one of the data blocks, and whatever erased block being allocated from among the erased blocks as a new scratch block, and,
if there occurs a shortage of the erased blocks, a data block containing a small amount of effective data being selected from among the data blocks as an erasing-target data block, and, after copying only the small amount of effective data into the scratch block from the erasing-target data block, the erasing-target data block being erased thereby to acquire an erased block.

5. The storage device according to claim 4, wherein
the RAM further stores therein a physical-block management table for performing management of the erasing number-of-times and effective-page number of each block.

6. The storage device according to claim 4, wherein
the scratch blocks and the data blocks are managed on each logical-group number basis, the respective logical-group numbers being created by partitioning the scratch blocks and the data blocks on each constant-amount basis.

7. A computer, comprising:
an instruction processing device; and
a storage device, wherein
the computer comprises, as the storage device,
the storage device according to claim 1.

8. A storage device, comprising:
a nonvolatile memory;
a RAM; and
a memory controller for performing data reading/writing processings from/into the nonvolatile memory and the RAM, wherein
the nonvolatile memory stores a plurality of partitioned translation tables, the plurality of partitioned translation tables being created by partitioning, in a predetermined unit, a logical-to-physical address translation table for managing storage locations of data,
the RAM storing a logical-to-physical address translation table cache for storing at least the one or more partitioned translation tables, a translation-table management table for managing the partitioned translation tables, and a cache management table for managing the logical-to-physical address translation table cache,
the translation-table management table being used for managing that the partitioned translation tables are stored into the logical-to-physical address translation table cache, and being used for managing storage destinations of the partitioned translation tables in the logical-to-physical address translation table cache,
reading/writing processings for the information in the logical-to-physical address translation table between the nonvolatile memory and the RAM being performed in the predetermined unit.

9. The storage device according to claim 8, wherein
the translation-table management table is used for determining a partitioned translation table which should be written into the nonvolatile memory from among the plurality of partitioned translation tables stored in the logical-to-physical address translation table cache.
